(19) United States
(12) Patent Application Publication
(10) Pub. No.: US 2022/0128497 A1
(43) Pub. Date: Apr. 28, 2022

(54) A MEASUREMENT MECHANISM

(71) Applicant: TUSAS- TURK HAVACILIK VE UZAY SANAYII ANONIM SIRKETI, Ankara (TR)

(72) Inventors: Deger AKIN, Kazan/Ankara (TR); Dilek KUMLUTAS, Bornova/Izmir (TR); Ahmet Bilge UYGUR, Kazan/Ankara (TR); Cem OMUR, Kazan/Ankara (TR); Hasan Gurguc ISIK, Kazan/Ankara (TR)

(73) Assignee: TUSAS- TURK HAVACILIK VE UZAY SANAYII ANONIM SIRKETI, Ankara (TR)

(21) Appl. No.: 17/296,500

(22) PCT Filed: Dec. 17, 2019
(86) PCT No.: PCT/TR2019/051091

§ 371 Date: May 24, 2021

(30) Foreign Application Priority Data
Dec. 28, 2018 (TR) 2018/21010

(51) Int. Cl. G01N 25/18; G01N 25/00; G01K 17/00

(52) U.S. Cl. CPC G01N 25/18; G01K 17/00; G01N 25/005

(57) ABSTRACT

A measurement assembly having a body, a vacuum chamber located on the body and in which the measurement process is carried out is disclosed. A first sample and a second sample that are placed in the vacuum chamber contact each other and between which a heat transfer occurs; a piston that provides the first sample and the second sample to continuously contact each other; a cooler located below the first sample and the second sample; and a heater located above the first sample and the second sample is also disclosed.

The present invention relates to a measurement mechanism which provides measuring thermal contact resistance.

Especially in space and air vehicles, honeycomb sandwich panels having carbon fibre-reinforced plate surfaces are commonly used. While various equipment and components provided in space vehicles may be fixed directly to such panels, the fixing process is performed by means of supports. Equipment, components and/or supports which are fixed to these panels may be made of metallic materials. For that reason, precise determination of thermal contact resistance, which is generated as a result of fixing the equipment, components and/or supports to the panels, is a significant factor for thermal control design of the space vehicle. While measuring the thermal contact resistance, it is provided that at least two samples contact each other. A heat transfer occurs between two samples. Meanwhile, the thermal contact resistance is measured by performing a measurement. Said test is executed in an environment without air interaction. A pressure allows two samples to be in a continuous contact with each other. The continuous pressure is provided by means of a high power piston. In order to be able to measure the thermal contact resistance between two samples, measurement units which measure heat flux are used. However, a single measurement is not sufficient in order to accurately measure thermal contact resistance of the non-homogenous samples. Moreover, evaluating the thermal contact resistances which are measured at various regions does not always give accurate results.

U.S. Pat. No. 5,940,784 covered by the known art discloses a measurement method for heat flux.

In another published document having the title of “Thermal contact conductance under low applied load in a vacuum environment” (KOICHI NISHINO ET AL: EXPERIMENTAL THERMAL AND FLUID SCIENCE, vol. 10, 1 Feb. 1995, pages 258-271), measurement of thermal contact conductance of test plates in a vacuum environment under low applied load is disclosed. During measurement, heat transfer is formed through the test plates that are contacting each other by heating from one side and cooling from the other side and a low pressure is applied by the bolts provided on the corners of the test chamber. During test, a pressure-measuring film that is capable of visualizing contact pressure distributions is used for predicting thermal contact conductance. Therefore, more accurate measurement results can be obtained although nonuniformities (such as different shapes of test plates) are present.

In the other published document having the title of “Thermal contact resistance across pressed metal contacts in a vacuum environment” (T. MCWAID ET AL: INTERNATIONAL JOURNAL OF HEAT AND MASS TRANSFER, vol. 35, 1 Nov. 1992, pages 2911-2920), measurement of thermal contact conductance as a function of contact pressure in a vacuum environment is disclosed. During measurement, heat transfer is formed through the test specimens that are contacting each other by heating from one side and cooling from the other side and a pressure is applied on the specimens by means of an actuator. In this document it is also stated that, in order to predict the thermal contact resistance across a pressed contact, both the average size and the number of contacts must be estimated as a function of load. Accordingly, contact resistance values are obtained as a function of contact pressure, surface texture and material properties.

An object of the present invention is to realize a measurement mechanism which provides ease of measurement.

The measurement mechanism aimed to achieve the object of the present invention and disclosed in the claims comprises a body and a vacuum chamber located on the body. The vacuum chamber comprises a first sample and a second sample, between which a heat transfer occurs, and a piston which exerts a continuous pushing force in order for the first sample and the second sample to contact each other.

The measurement mechanism, which is the subject matter of the present invention, comprises a heat flux converter which is located to fully cover the first sample and/or the second sample comprising carbon fibre and/or aluminium material. Due to the fact that the heat flux converter fully covers the first sample and/or the second sample, heat flux measurement can be conducted at different regions on the samples.

In an embodiment of the invention, the measurement mechanism comprises a first sample and/or a second sample having a non-homogenous surface form. Shapes and densities of the first sample and/or the second sample are not same in each region.

In an embodiment of the invention, the measurement mechanism comprises a first sample and/or a second sample having a honeycomb form. Thereby, pores are located on the first sample and/or the second sample. During the heat flux measurement process, the measurement quality is improved by defining the gaps by means of the heat flux converter.

In an embodiment of the invention, the measurement mechanism comprises a heat flux converter having an elastic form. Due to the fact that the heat flux converter has an elastic form, it is provided that the heat flux converter fully adheres to the first sample and/or the second sample and takes the shape of the first sample and/or the second sample. Thus, the measurement precision is improved.

In an embodiment of the invention, the measurement mechanism comprises a plurality of measurement points located on the heat flux converter, and a control unit for evaluating the information received from the measurement points. Due to the fact that the measurement points are located at different regions of the first sample and/or the second sample, different thermal contact resistance and thermal conductivity data are obtained and these data are compared with data which are predefined on the control unit by the manufacturer.

In an embodiment of the invention, the measurement mechanism comprises a control unit for determining a surface area of the first sample and/or the second sample depending on the heat flux data received from the measurement points. Thus, sample sizes are calculated.

In an embodiment of the invention, the measurement mechanism comprises a conductivity sensor which is located between the heat flux converter and the first sample and/or the second sample. The information obtained by means of the conductivity sensor is transferred to the control unit. The information is compared with the data, which are predetermined on the control unit by the manufacturer, to determine material type of the first sample and the second sample.

With the invention, there is realized a measurement mechanism for measuring thermal conductivity and thermal contact resistances of the samples which comprise carbon fibre and aluminium materials and have a non-homogenous surface area.

The measurement mechanism aimed to achieve the object of the present invention is illustrated in the attached figures, in which:

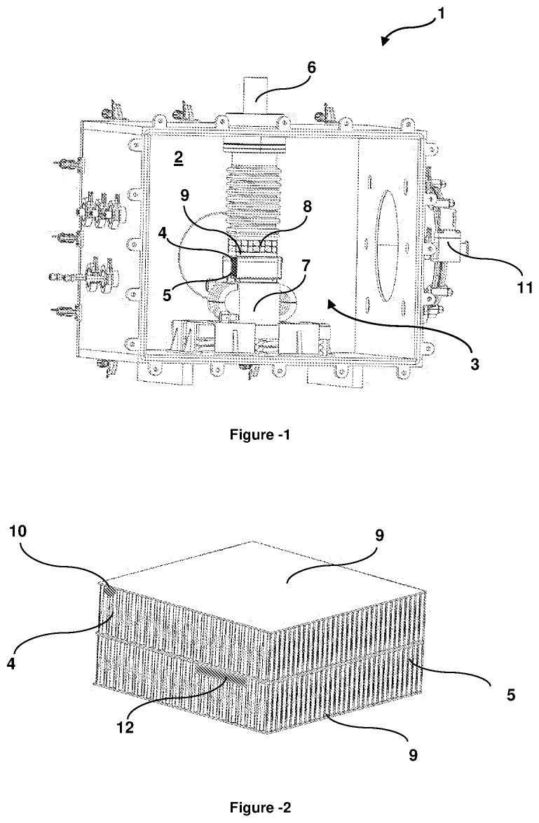

FIG. 1 is a perspective view of a measurement mechanism.

FIG. 2 is a perspective view of the first sample, the second sample, the heat flux converter, the measurement point and the conductivity sensor.

All the parts illustrated in figures are individually assigned a reference numeral and the corresponding terms of these numbers are listed below.
1—Measurement mechanism
2—Body
3—Vacuum chamber
4—First sample
5—Second sample
6—Piston
7—Cooler
8—Heater
9—Heat flux converter
10—Measurement point
11—Control unit
12—Conductivity sensor

The measurement assembly (1) comprises a body (2); a vacuum chamber (3) located on the body (2) and in which the measurement process is carried out; a first sample (4) and a second sample (5) which are placed in the vacuum chamber (3), contact each other and between which a heat transfer occurs; a piston (6) which provides the first sample (4) and the second sample (5) to continuously contact each other; a cooler (7) located below the first sample (4) and the second sample (5); and a heater (8) located above the first sample (4) and the second sample (5). Thanks to the vacuum chamber (3), there is created a test assembly which is independent from the outer environment conditions. A heat flow is generated between the heater (8) and the cooler (7), thus measuring the thermal contact resistances of the samples (4, 5).

The measurement assembly (1) of the invention comprises a heat flux converter (9) which is located to fully cover the first sample (4) and/or the second sample (5), which have a surface comprising carbon fibre and/or aluminium material, to measure the thermal contact resistance thereof. Due to the fact that the heat flux converter (9) fully covers the first sample (4) and the second sample (5), thermal contact resistances of the samples (4, 5) which are made of strong materials such as carbon fibre or aluminium are able to be measured.

In an embodiment of the invention, the measurement assembly (1) comprises a heat flux converter (9) for measuring the thermal contact resistance of the first sample (4) and/or the second sample (5) having a non-homogenous surface form. The heat flux converter (9) spreads homogenously over the sample. Therefore, it is provided that the thermal contact resistance of the samples (4, 5) having different forms and shapes is measured.

In an embodiment of the invention, the measurement assembly (1) comprises a heat flux converter (9) for measuring the thermal contact resistance of the first sample (4) and/or the second sample (5) having a honeycomb form. The heat flux converter (9) can provide various measurements at different areas. Therefore, the thermal contact resistance of the samples (4, 5) having honeycomb form can be measured.

In an embodiment of the invention, the measurement assembly (1) comprises a heat flux converter (9) having an elastic form. Due to the fact that the heat flux converter (9) has an elastic form, it is provided that the heat flux converter takes the shape of the samples (4, 5). Therefore, the sample and the heat flux converter (9) fully contact and the accurate thermal contact resistance can be measured.

In an embodiment of the invention, the measurement assembly (1) comprises a plurality of measurement points (10) located on the heat flux converter (9), and a control unit (11) for comparing the information received from the measurement points (10). The thermal contact resistance is measured via the measurement points (10), samples (4, 5). The thermal contact resistance data measured are transferred to the control unit (11). These are compared with the data, which are predefined on the control unit (11) by the manufacturer, to determine thermal contact data.

In an embodiment of the invention, the measurement assembly (1) comprises a control unit (11) for measuring a surface area of the first sample (4) and/or the second sample (5) according to the information received from the measurement points (10). Due to the fact that the thermal contact data received from the measurement points (10) are transferred to the control unit (11), surface area of the samples (4, 5) is able to be determined. Therefore, sample size is determined and a user is informed.

In an embodiment of the invention, the measurement assembly (1) comprises a conductivity sensor (12) which is located between the heat flux converter (9) and the first sample (4) and/or the second sample (5) and contacts the first sample (4) and/or the second sample (5), and a control unit (11) for determining material type of the first sample (4) and/or the second sample (5) according to the information received from the conductivity sensor (12). Conductivity data received from the conductivity sensor (12) are compared with the conductivity data, which are predefined on the control unit (11) by the manufacturer, to determine material type of the sample.

The invention relates to a measurement assembly (1) comprising a heat flux converter (9) which provides measuring a thermal contact resistance by covering the samples (4, 5) so that there is no gap in between. Therefore, it is provided that the measurement accuracy for the thermal contact resistance of the samples (4, 5) is improved.

1. A measurement mechanism (1) comprising a body (2); a vacuum chamber (3) located on the body (2) and in which the measurement process is carried out; a first sample (4) and a second sample (5) which are placed in the vacuum chamber (3), contact each other and between which a heat transfer occurs; a piston (6) which provides the first sample (4) and the second sample (5) to continuously contact each other; a cooler (7) located below the first sample (4) and the second sample (5); and a heater (8) located above the first sample (4) and the second sample (5), characterized by a heat flux converter (9) which fully covers the first sample (4) and the second sample (5) to measure the thermal contact resistance thereof, wherein the samples have a surface comprising carbon fibre and/or aluminium material, said first sample (4) and/or second sample (5) have a honeycomb form and said heat flux converter (9) having an elastic form so that the samples and the heat flux converter (9) fully contact.

2-4. (canceled)

5. A measurement assembly (1) according to claim 1, characterized by a plurality of measurement points (10) located on the heat flux converter (9), and a control unit (11) for comparing the information received from the measurement points (10).

6. The measurement assembly (1) according to claim 5, characterized by a control unit (11) for measuring a surface area of the first sample (4) and/or the second sample (5) according to the information received from the measurement points (10).

7. (canceled)
